(19) United States
(12) Patent Application Publication
(10) Pub. No.: US 2014/0074640 A1
(43) Pub. Date: Mar. 13, 2014

(54) TECHNIQUES TO AUCTION A PORTION OF A WEB PAGE

(71) Applicants: George B. Gleadall, Boca Raton, FL (US); Ronnie Paskin, Ft. Lauderdale, FL (US); Shawn J. Stewart, Wake Forest, NC (US)

(72) Inventors: George B. Gleadall, Boca Raton, FL (US); Ronnie Paskin, Ft. Lauderdale, FL (US); Shawn J. Stewart, Wake Forest, NC (US)

(73) Assignee: CBS INTERACTIVE INC., San Francisco, CA (US)

(21) Appl. No.: 13/607,336

(22) Filed: Sep. 7, 2012

(51) Int. Cl. G06Q 30/08

(52) U.S. Cl. 705/26.3

(57) ABSTRACT

Techniques to auction a portion of a web page are described. A computer implemented application may receive a selection indicative of a portion of a web page from a website to be auctioned. The computer implemented application may accept bids from one or more bidders for the portion of the web page and receive payment for the portion of the web page from a winning bidder. The computer implemented application may receive text and/or graphics to be inserted into the portion of the web page and re-construct the web page by placing the received text and/or graphics into the portion of the web page. Other embodiments are described and claimed.

### BACKGROUND

Fantasy games, such as fantasy game sports leagues, are commonly computer driven ventures that link multiple participants together over a network such as the Internet. Fantasy game sports leagues allow the participants to create fantasy game teams using the actual players of a real sports league. The fantasy game teams may then compete against one another to determine which participant has put together the best fantasy game team. Typically, the participants in a fantasy game league hold a draft in which each participant selects actual players to make up their fantasy game team. Once the teams have been formed, games may be scheduled and played. While not all fantasy game leagues operate under the same rules, they typically score fantasy games based on the individual statistics of the actual players in actual games on the date of the fantasy game. Thus, a fantasy game team owner (e.g., participant) may select a predetermined number of actual players to make ‘active’ on a given date. The statistics of these active players is then used to determine a point value. The point value for each active player on a fantasy game team is summed to yield the fantasy game team's overall score for that night. The score may then be compared to the score of another fantasy game team to determine a winner for that night.

For instance, fantasy game team A may be scheduled to compete against fantasy game team B on Monday. The team owners for fantasy game teams A and B designate the active players for Monday and the actual games are played. The statistics of the actual players for Monday's actual games are used to calculate the point totals for the corresponding fantasy game players and to determine the outcome of a game between two competing fantasy game teams.

One of the attractions of fantasy game leagues is that players need not come from the same actual teams. A fantasy game team may be comprised of actual players from multiple actual teams. This allows the fantasy game team owners to act as armchair general managers and mold a team according to their own philosophy. This naturally leads to competition among the fantasy game team owners. The competitive spirit makes the fantasy game leagues successful. The competition among the fantasy game team owners may be further developed and monetized to some extent by providing an outlet allowing the competitive nature of the fantasy game team owners to be shared.

### BRIEF DESCRIPTION OF THE DRAWINGS

FIG. 1 illustrates an embodiment of a computer screen image for a fantasy game league home page.

FIG. 2 illustrates an embodiment of a computer screen image for a fantasy game team home page.

FIG. 3 illustrates an embodiment of a computer screen image for a fantasy game page.

FIG. 4 illustrates a block diagram of an embodiment of a fantasy game league system.

FIG. 5 illustrates an embodiment of a user computer device communicable with the fantasy game league web server.

FIG. 6 illustrates an embodiment of a mobile user device communicable with the fantasy game league web server.

FIG. 7 illustrates an embodiment of a computer screen image showing a list of fantasy game pages that may be auctioned.

FIG. 8 illustrates an embodiment of a computer screen image showing the status of a particular fantasy game page.

FIG. 9 illustrates an embodiment of a computer screen image showing a bidding status for a fantasy game page.

FIG. 10 illustrates an embodiment of a computer screen image for entering data pertaining to a bid for a fantasy game page.

FIG. 11 illustrates an embodiment of a computer screen image for entering data pertaining to a hostile takeover bid for a fantasy game page.

FIG. 12 illustrates an embodiment of a computer screen image for entering data to respond to a hostile takeover bid for a fantasy game page.

FIG. 13 illustrates a logic flow diagram.

FIG. 14 illustrates a logic flow diagram.

FIG. 15 illustrates a logic flow diagram.

FIG. 16 illustrates an embodiment of a computing architecture.

### DETAILED DESCRIPTION

Various embodiments are generally directed to fantasy games. In general, a game is a system in which players engage in an artificial conflict, defined by rules and a scoring system, resulting in a quantifiable outcome. A fantasy game is a game based on a quantifiable outcome of another game. More particularly, a fantasy game uses a scoring system that is based, at least in part, on a quantifiable outcome of another game in order to obtain a quantifiable outcome for the fantasy game. For instance, a fantasy game sport game may comprise a fantasy game team selected from human players of a real sport. The fantasy game sport game may convert statistical information of human player performance in real sporting competitions (e.g., a football game, a baseball game, etc.) into points that are compiled and totaled according to a roster of a fantasy game team. Fantasy game players of the fantasy game sport game then compete based on the totaled points.

Fantasy games may be based on any type or genre of games. Some examples of games may include without limitation sports, board games, video games, lawn games, tabletop games, party games, dexterity games, coordination games, card games, dice games, domino and tile games, guessing games, video games, electronic games, electronic video games, online games, role-playing games, business games, simulation games, television games, reality television games, artificial reality games, and so forth. A fantasy game may be based on any of these or other types of games. A particularly large segment of fantasy games focus on sports, such as football, basketball, baseball, soccer, hockey, racing, and so forth. Recently, emerging fantasy game genres have branched out to include non-sports related games focused on politics, celebrity gossip, movies, and reality television. For instance, fantasy game congress is a fantasy game where players, called citizens, could draft members of the United States House and Senate, and keep track of their participation within the U.S. Congress. Actions, especially within the process of making and amending pieces of legislation, of a player's drafted congresspersons are recorded and rated as a cumulative total amount of points against other players. The embodiments are not limited in this context.

Fantasy games may have many fantasy game genres. For example, fantasy game sport is a class of fantasy games. A fantasy game owner might draft a fantasy game football team to compete with other fantasy game football teams based on statistics generated by real football players from the National Football League (NFL). Fantasy game reality TV is another class of fantasy games. For instance, a fantasy game owner might draft a fantasy game reality team to compete with other fantasy game reality teams based on statistics generated by reality show contestants, such as contestants for such reality shows as Big Brother, Survivor, American Idol, Dancing With The Stars, The Apprentice, Fear Factor, The Amazing Race, and so forth. Fantasy game board is another class of fantasy games. For instance, a fantasy game owner might draft a fantasy game board game team to compete with other fantasy game board game teams based on statistics generated by board game contestants, such as chess players, poker players, checker players, monopoly players, or other board games. Fantasy game electronic is another class of fantasy games. For instance, a fantasy game owner might draft a fantasy game electronic game team to compete with other fantasy game electronic game teams based on statistics generated by electronic game contestants, such as electronic video game players, electronic gambling game players, and other electronic games. The embodiments are not limited in this context.

Creating an opportunity for fantasy game team owners to further display their competitive spirit may lead to additional monetization opportunities for the websites that run fantasy game leagues. One such mechanism may involve selling or auctioning space on webpages associated with fantasy game league to the team owners. Those who purchase the space may upload text or graphics touting their accomplishments for all to see. This may be a form of “trash talking” meant to stoke the competitive nature of the team owners. Moreover, the team owners' own web pages may be made available for auction meaning that a rival team owner may buy space on another team owner's fantasy game home page and upload text and graphics, graffiti of sorts, on the web page. This may lead to counter purchases adding to the revenue of the fantasy game website. In addition, the opportunity to buy back the auctioned portion of a web page may provide further competition and monetization opportunities.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

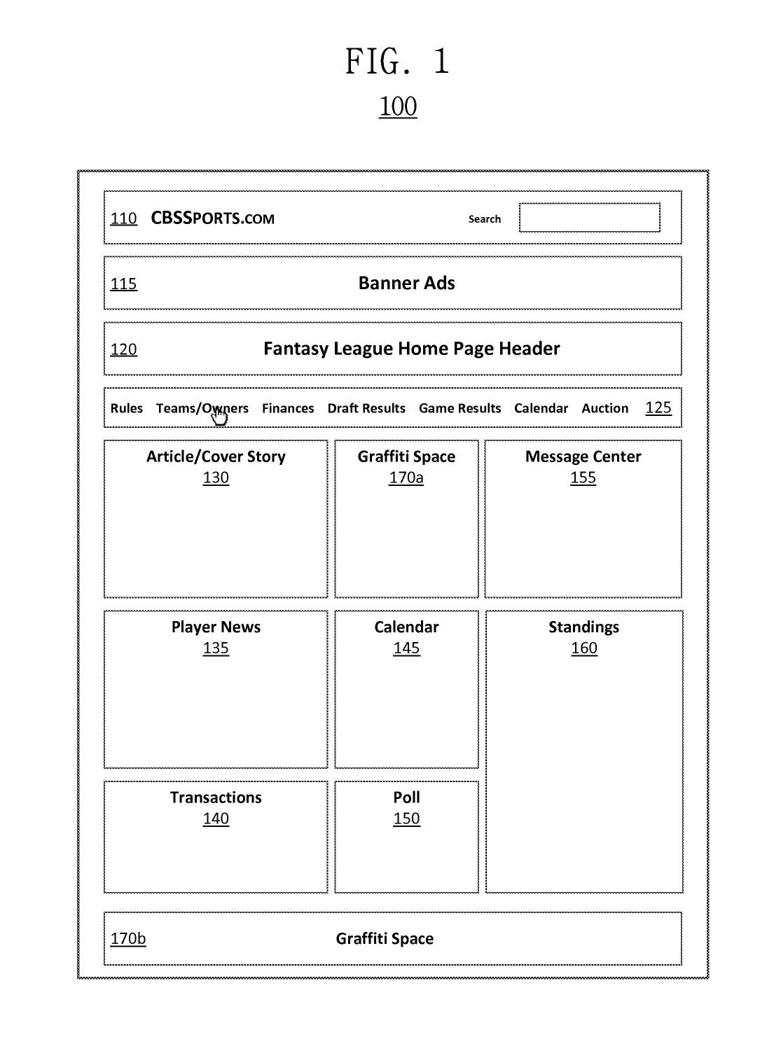

FIG. 1 illustrates an embodiment of a computer screen image for a fantasy game league home page 100. The fantasy game league home page 100 may be considered the home page for a fantasy game league website that hosts the fantasy game league. The fantasy game league home page 100 may present information relevant to the fantasy game league team owners and provide links to more detailed information regarding the fantasy game league that may not be able to be presented all on the fantasy gamefantasy game league home page 100. In this embodiment, the fantasy gamefantasy game league home page 100 may be comprised of multiple sections. For instance, the fantasy gamefantasy game league home page 100 may include a sponsor banner 110 that includes a search engine box that accepts input for searches on the website. The fantasy game league home page 100 may also include a section for banner advertisements 115. The banner advertisements may be typical web advertisements that occupy a portion of the fantasy game league home page 100. The fantasy game league home page 100 may also include a fantasy game league home page header section 120. This section may identify the name of the fantasy game league chosen by the team owners as well as the sport associated with the fantasy game league. For example, the fantasy game league home page header section 120 may read “JIMBO'S 2012 FANTASY HOCKEY LEAGUE”. The embodiments are not limited to this example.

The fantasy game league home page 100 may also include a menu bar 125 comprised of multiple tabs that act as hyperlinks to other webpages within the fantasy game league website. The tabs may include, but are not limited to, a rules tab, a team/owners tab, a finances tab, a draft results tab, a game results tab, a calendar tab, and an auction tab.

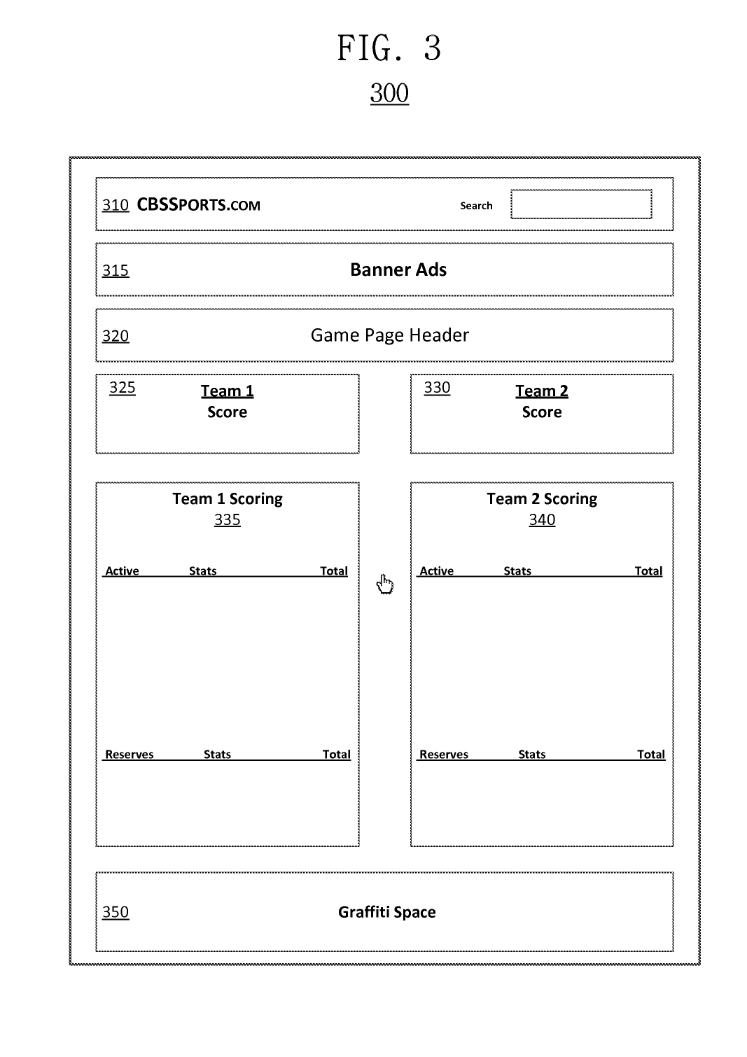

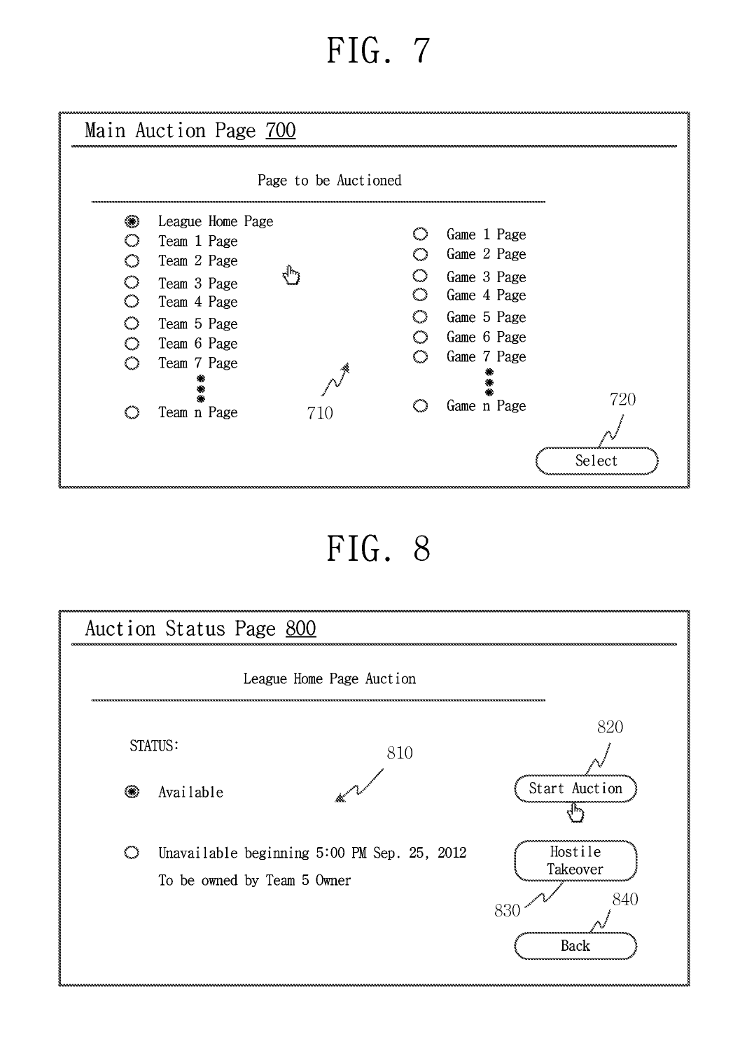

The rules tab, when selected, may send the user to a web page that describes the rules by which the fantasy game league operates. This may include, among other things, the rules for drafting players and transacting players (e.g., waivers and trades). The teams/owners tab, when selected, may send the user to a web page that lists all of the team and owner names for the fantasy game league. Moreover, the team names may be hyperlinked such that selecting a team may send the user to that team's home web page. The finances tab, when selected, may send the user to a web page that lists all the financial obligations of each team in the league. This may include, among other things, player salaries and, if a salary cap applies, the amount of room under the salary cap. The draft results tab, when selected, may send the user to a web page that lists a round by round selection of players by each of the teams. The game results tab, when selected, may send the user to a web page that stores the results of every fantasy league game that has been played to date among the fantasy game teams. Each game may be presented in an abbreviated format such as total score. The game may be hyperlinked such that, when clicked, the user is presented with a detailed account of the selected game which may include individual statistics for each player for each team. An example of a detailed fantasy game page is provided with reference to FIG. 3 below. The calendar tab, when selected, may send the user to a web page that lists, in calendar format, a schedule of all fantasy league games. For instance, Tuesday's schedule may include games between Team B vs. Team E, Team D vs. Team C, and Team A vs. Team F. The auction tab, when selected, may send the user to a web page that presents all of the web pages within the fantasy game league website that are available for auction. An example of such a web page is presented below with reference to FIG. 7.

The fantasy game league home page 100 may further include sections such as, for instance, an article section 130, player news section 135, transactions section 140, a calendar snapshot section 145, a poll question section 150, a message center section 155, a standings section 160, and one or more graffiti space sections 170a-b.

The article section 130 may include an article relevant to the team owners that pertains to fantasy game sports in general or the underlying sport, etc. The article section 130 is typically not large enough to accommodate the entire article. The bottom portion of the article section may include a hyperlink labeled more or the like that when clicked will take the user to a web page containing the full article. The player news section 135 may include articles or news specific to individual players. This may include, but is not limited to, season or career milestones, contract negotiation updates, and injury updates. Typically, the player name will be hyperlinked such that clicking on the link will send the user to another web page that provides more detail on the player in question. The transactions section 140 may include a log of daily, weekly, and seasonal transactions performed by each of the teams in the fantasy game league. The transactions may be hyperlinked such that clicking on the link will send the user to another web page that provides more detail on the transaction in question. The calendar snapshot section 145 may provide a listing of that day's games only. A user may obtain additional calendar/schedule information by clicking the “calendar” tab on the menu bar 125 as previously described. The poll section 150 may be a convenience feature that the fantasy game league home page 100 uses to elicit and present information to the team owners. The purpose of the poll section 150 may be to use information collected to enhance the fantasy game league website. The message center section 155 may permit each team owner (e.g., registered user) to post a message for all other team owners to see. The standings section 160 may present an updated listing of the won-loss record for each of the teams in the fantasy game league. The graffiti space sections 170a-b may be space reserved on the fantasy game league home page 100. This space may be auctioned off to any one of the teams/owners. The team/owner that successfully purchases a graffiti space section 170a-b may then upload their own text or graphics (e.g., graffiti) to the space for all to see. As a default, the graffiti space 170a-b may be under the control of the web page owner when it is not subject to the results of an auction.

It should be noted that the size, shape, arrangement, content and overall presentation of the fantasy game league home page 100 in FIG. 1 may be altered or amended to suit a particular need or design. As such, the fantasy game league home page 100 is exemplary and not intended to be limiting of this disclosure. The embodiments are not limited to this example.

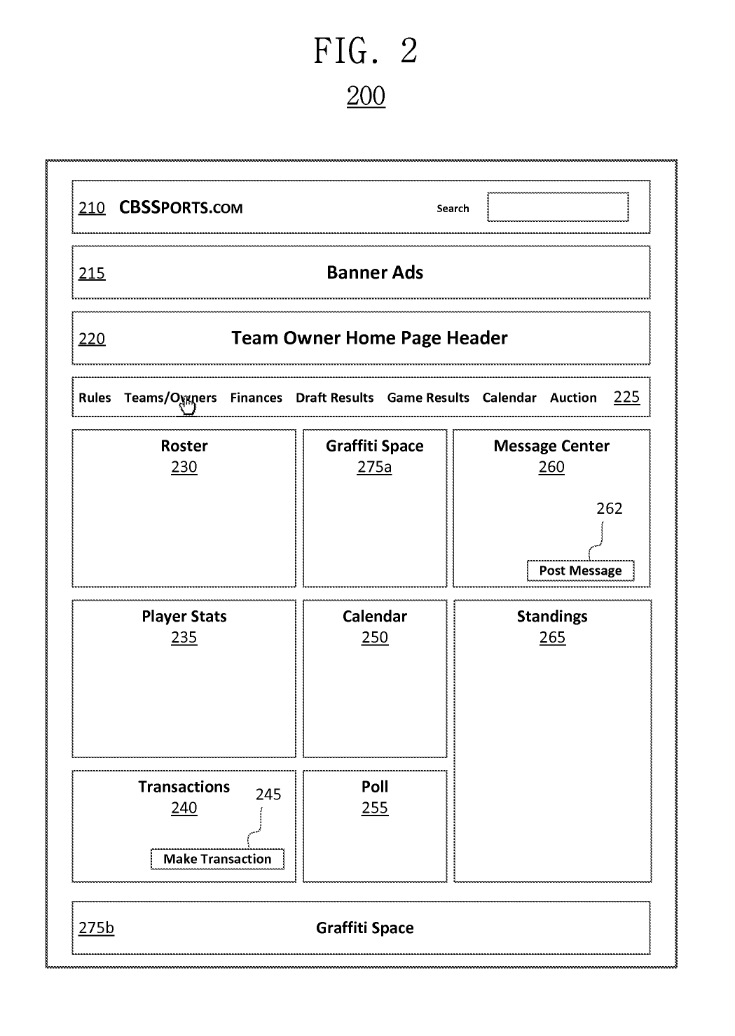

FIG. 2 illustrates an embodiment of a computer screen image for a fantasy game team home page 200. The fantasy game team home page 200 may be considered the home page for a fantasy game team. The fantasy game team home page 200 may present information relevant to the fantasy game team and provide links to more detailed information regarding the fantasy game team that may not be able to be presented all on the fantasy game team home page 200. In this embodiment, the fantasy game team home page 200 may be comprised of multiple sections. For instance, the fantasy game team home page 200 may include a sponsor banner 110 that includes a search engine box that accepts input for searches on the website. The fantasy game team home page 200 may also include a section for banner advertisements 115. The banner advertisements may be typical web advertisements that occupy a portion of the fantasy game team home page 200. The fantasy game team home page 200 may also include a fantasy game team owner home page header section 220. This section may identify the name of the team chosen by the team owner. For example, the fantasy game league home page header section 220 may read “THE SWAMP RATS”. A small graphic or logo may also be included in the fantasy game league home page header section 220. The embodiments are not limited to this example.

The fantasy game team home page 200 may also include a menu bar 125 comprised of multiple tabs that act as hyperlinks to other webpages within the fantasy game league website. The tabs may include, but are not limited to, a rules tab, a team/owners tab, a finances tab, a draft results tab, a game results tab, a calendar tab, and an auction tab. These tabs are the same as those described with respect to the fantasy game league home page 100 of FIG. 1. As such, a description of each tab has already been made.

The fantasy game team home page 200 may further include sections such as, for instance, a roster section 230, player stats section 235, transactions section 240, a calendar snapshot section 250, a poll question section 255, a message center section 260, a standings section 265, and one or more graffiti space sections 275a-b.

The roster section 230 may include a list of all the players currently on the team. The player stats section 135 may include season long statistics for each player on the roster. This may include, but is not limited to, points accumulated for the fantasy game team thus far. Typically, the player name will be hyperlinked such that clicking on the link will send the user to another web page that provides more detail on the statistics of the player in question. The transactions section 240 may include a log of daily, weekly, and seasonal transactions performed by the team. The transactions may be hyperlinked such that clicking on the link will send the user to another web page that provides more detail on the transaction in question. In addition, a “make Transaction” button 245 may be included that will send the user to a webpage directed toward making player transactions including trades and free agent pick-ups. The calendar snapshot section 250 may provide a listing of the teams games for the day or week. A user may obtain additional calendar/schedule information by clicking the “calendar” tab on the menu bar 225. The poll section 255, the message center section 260, and the standings section 265 are identical to the corresponding sections described with reference to FIG. 1 above and are not repeated. The graffiti space sections 275a-b may be space reserved on the fantasy game team home page 200. This space may be auctioned off to any one of the teams/owners. The team/owner that successfully purchases a graffiti space section 275a-b may then upload their own text or graphics (e.g., graffiti) to the space for all to see. It may be especially enticing to purchase space on a rival's page and upload graffiti that tout's your accomplishments at their expense. As a default, the graffiti space 275a-b may be under the control of the web page owner when it is not subject to the results of an auction.

It should be noted that the size, shape, arrangement, content and overall presentation of the fantasy game team home page 200 in FIG. 2 may be altered or amended to suit a particular need or design. As such, the fantasy game team home page 200 is exemplary and not intended to be limiting of this disclosure. The embodiments are not limited to this example.

FIG. 3 illustrates an embodiment of a computer screen image for a fantasy game page 300. The fantasy game page 300 may be considered the home page for a particular game played within the fantasy league. The fantasy game page 300 may present information relevant to the fantasy game and provide links to more detailed information regarding the fantasy game that may not be able to be presented all on the fantasy game page 300. In this embodiment, the fantasy game page 300 may be comprised of multiple sections. For instance, the fantasy game page 300 may include a sponsor banner 110 that includes a search engine box that accepts input for searches on the website. The fantasy game page 300 may also include a section for banner advertisements 115. The banner advertisements may be typical web advertisements that occupy a portion of the fantasy game page 300. The fantasy game page 300 may also include a fantasy game page header section 320. This section may identify the name of the teams competing in the game as well as their current won-loss record. The embodiments are not limited to this example.

The fantasy game page 300 may also include sections for team scores 325, 330, sections for player scoring 335, 340, and a section for graffiti space 350. The team score sections 325, 330 may include the team name and current score prominently displayed such that the game score is readily and easily discernible by anyone viewing the fantasy game page 300. The player scoring sections 335, 340 may list each active player and the amount of points tallied so far. The points of the active players may be summed to yield the current team score. The player scoring sections 335, 340 may further include a listing of reserve players and points tallied even though the reserve player points do not factor into the team score. The graffiti space 350 may be reserved on the fantasy game page 300 to be auctioned off to any one of the teams/owners. The team/owner that successfully purchases the graffiti space section 250 may then upload their own text or graphics (e.g., graffiti) to the space for all to see. As a default, the graffiti space 350 may be under the control of the web page owner when it is not subject to the results of an auction.

It should be noted that the size, shape, arrangement, content and overall presentation of the fantasy game page 300 in FIG. 3 may be altered or amended to suit a particular need or design. As such, the fantasy game page 300 is exemplary and not intended to be limiting of this disclosure. The embodiments are not limited to this example.

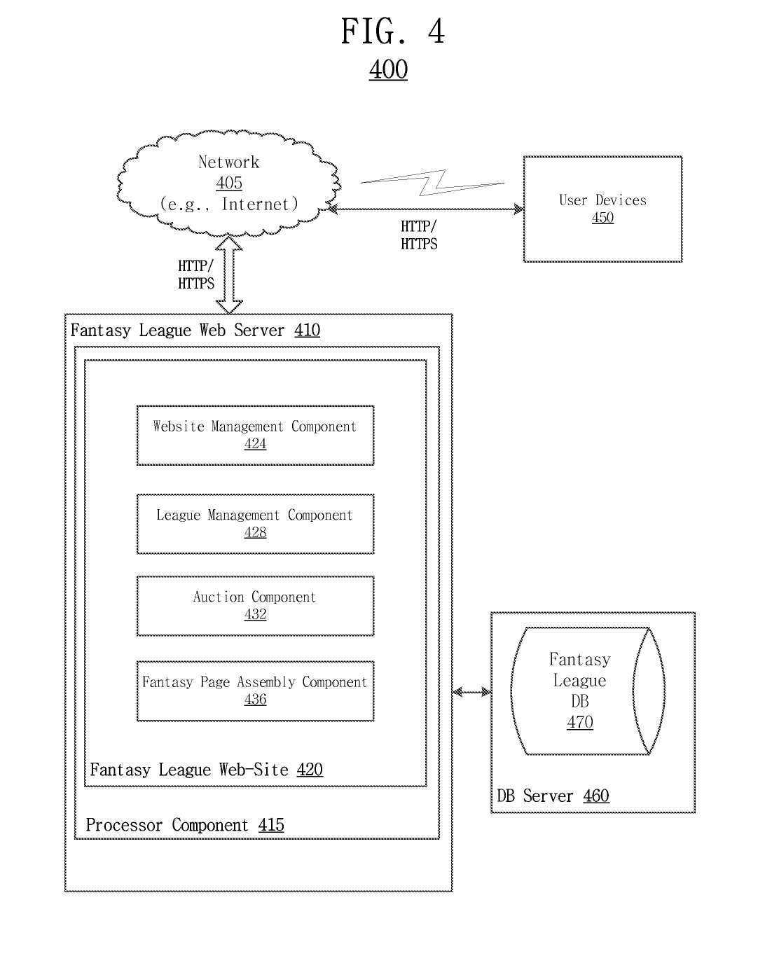

FIG. 4 illustrates a block diagram of an embodiment of a fantasy game league system 400. In one embodiment, the fantasy game league system 400 may comprise a computer-implemented system having one or more components. Although the fantasy game league system 400 shown in FIG. 4 has a limited number of elements or components in a certain topology, it may be appreciated that the fantasy game league system 400 may include more or less elements or components in alternate topologies as desired for a given implementation.

The fantasy game league system 400 may include a network device, such as a fantasy game league web server 410. The fantasy game league web server 410 may be generally arranged to host and execute one or more additional fantasy game league system components. For instance, the fantasy game league web server 410 may host a fantasy game league website 420. The fantasy game league website 420 may be stored on the fantasy game league web server 410 and operable on a processor component 415.

When a user via a web browser seeks access to the fantasy game league website 420, access may be granted over a connection such as, for instance, the Hypertext Transfer Protocol (HTTP). HTTP is an application protocol for distributed communication among networked computers. HTTP is the protocol to exchange or transfer hypertext. HTTP functions as a request-response protocol in the client-server computing model. In this case, a web browser, for example, may be the client and an application running on processor component 415 hosting fantasy game league website 420 may be the fantasy game league web server 410. The client submits an HTTP request message to the fantasy game league web server 410. The fantasy game league web server 410, which provides resources such as Extensible Markup Language (XML) files, Hypertext Markup Language (HTML) files and other content, or performs other functions on behalf of the client, returns a response message to the client. The response contains completion status information about the request and may also contain requested content in its message body.

Certain parts of fantasy game league website 420 may include information and applications that are specific and unique to individual users of the fantasy game league website 420. Thus, when one of these users accesses the fantasy game league website 420, it can be done over a secure connection such as, for instance, the Hypertext Transfer Protocol Secure (HTTPS) or other secure communications protocol.

HTTPS is a communications protocol for secure communication over a computer network. HTTPS is widely deployed on the Internet. HTTPS is the result of layering HTTP on top of a secure socket layer (SSL)/transport layer security (TLS) protocol, thus adding the security capabilities of SSL/TLS to standard HTTP communications. HTTPS may provide authentication of the fantasy game league website 420 and associated fantasy game league web server 410 with which a remote computer is communicating over a network. HTTPS provides bidirectional encryption of communications between a client and fantasy game league web server 410, protecting against eavesdropping and tampering with and/or forging the contents of a communication. In the present example, HTTPS provides a reasonable guarantee that a remote computer is communicating with the intended fantasy game league website 420 and ensures the contents of communications between the user and fantasy game league website 420 cannot be read or forged by a third party. Other protocols, including but not limited to, websockets or the User Datagram Protocol (UDP), may be used as well, and the embodiments are not limited in this context.

The fantasy game league web server 410 may be communicable over a network 405 such as, for instance, the Internet. In turn, the network 405 may be communicable with multiple network enabled user devices 450 using wired or wireless communications mediums. The connections between the network enabled user devices 450 and the fantasy game league web server 410 over network 405 may be achieved using the aforementioned HTTP or HTTPS depending on the part of the fantasy game league website 420 with which a network enabled user device 450 wishes to communicate.

The fantasy game league website 420 may include multiple components. The multiple components may include, for instance, a website management component 424, a league management component 428, an auction component 432, and a fantasy game page assembly component 436.

The website management component 424 may comprise a software application operative on the processor component 415 that controls the administrative functions of the fantasy game league website 420. The website management component 424 may be generally arranged to manage the interfaces between the fantasy game league website 420 and other external components such as the network 405 (e.g., Internet) and multiple databases. For example, the fantasy game league website 420 may be communicable with a database server 460. The database server 460 may be communicable with the fantasy game league web server 410 over a local network connection or bus line and may include a fantasy game league database 470. Communications with the fantasy game league database 470 may be performed by, for instance, a structured query language (SQL) interface. The embodiments are not limited to these examples.

The fantasy game league database 470 may store without limitation information pertaining to user registration such as login data, billing information, user information such as contact data, player data, transaction data, draft data, and game data. The embodiments are not limited to these examples.

The website management component 424 may be further arranged to manage the fantasy game league website 420 accounts of end users and access by end users to the fantasy game league web site 420. There may be two types or levels of fantasy game league website users—client users and website administrators. Website administrators may control information and services provided to the users on the protected and public parts of the fantasy game league website 420. Website administrators may collect information and generate reports pertaining to user activities such as subscriptions, payments, registrations, etc. Users may use the fantasy game league website 420 to subscribe to various services provided by the fantasy game league website 420.

The website management component 424 may be further arranged to manage a user registration process. Registration may entail creating a private user identifier (ID)/password pair using a secure socket layer (SSL) protected website form that corresponds with the user. A registered user may login to the fantasy game league website 420 by providing their private user ID/password pair. A user's User ID and password may be stored in the fantasy game league database 470.

The league management component 428 is another feature of the fantasy game league website 420 and may comprise a software application operative on the processor component 415 generally arranged to interact with user devices 450 and manage the fantasy game league. For instance, the league management component 428 may coordinate and execute a player draft for the benefit of the fantasy game teams that comprise the fantasy game league, compose and execute a schedule of fantasy games among the fantasy game teams, track and score the players and fantasy games, assemble standings, conduct player transactions, provide a message center, conduct polls, and present various articles. The embodiments are not limited to these examples.

The auction management component 432 is yet another feature of the fantasy game league website 420 and may comprise a software application operative on the processor component 415 generally arranged to provide users the opportunity to purchase a portion of a fantasy game league web page for a limited period of time via an auction type transaction for the purpose of posting text and graphics on the purchased portion of the web page. The text and graphics may be referred to herein collectively as graffiti or graffiti content.

The fantasy game league web pages available for auction may include the fantasy game league home page, the home pages for the various teams in the fantasy game league, and the game pages for the various fantasy league games. The auction component may first allow a user to select which page to purchase a portion of via an auction. If the page is available, an auction process may be commenced. If the page is unavailable (e.g., already auctioned), the user may instigate a hostile takeover that essentially re-opens the auction for the remaining period of time specified in the initial auction. A bidding process may ensue and the top bidder is awarded the page space.

The page assembly component 436 is another still another feature of the fantasy game league website 420 and may comprise a software application operative on the processor component 415 generally arranged to assemble and present the various web pages that comprise the fantasy game league website 420 to users. The content of the various web pages may be obtained from the league management component 428 and the auction component 432. The fantasy game page assembly component 436 may then organize or arrange the content for the various web pages that comprise the fantasy game league website 420. Once assembled, the web pages may be presented to the user(s) that have requested access to the web page(s). Thus, the page assembly component 436 may insert any graffiti content that resulted from an auction for a portion of a web page into the web page at issue. The top bidder may then upload graffiti to the page assembly component where it may be screened to ensure it complies with any decency standards required by the fantasy game league website 420. The graffiti content, once approved, may then be inserted into the web page at issue.

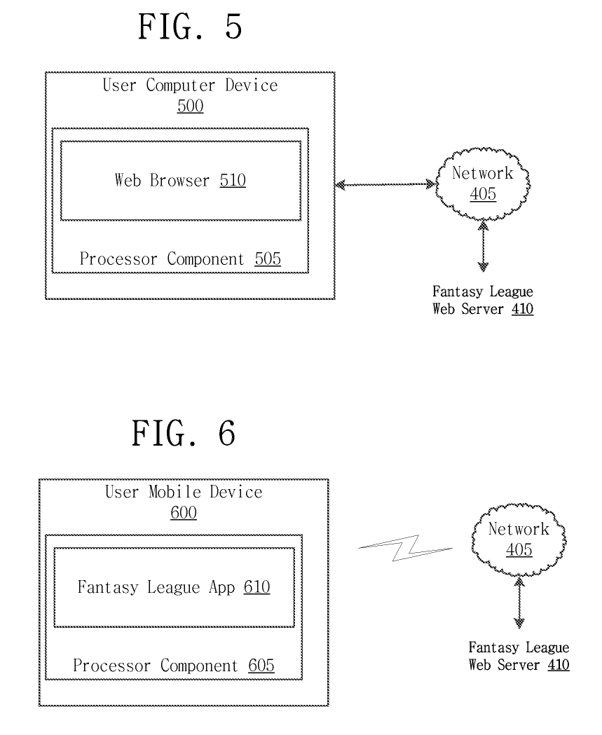

FIG. 5 illustrates an embodiment of a computer device 500 communicable with the fantasy game league website 420. The computer device 500 may be one example of a user device 450 shown in FIG. 4. The computer device 500 may take the form of a personal computer or a laptop computer. The embodiments are not limited to these examples, however. Specifically, the computer device 500 may include a web browser application 510 operative on a processor component 505. The web browser application 510 may access the fantasy game league web server 410 and, in turn, the fantasy game league website 420 over the network 405. If a login procedure is required to access the fantasy game league website 420, the user may be asked to provide a username/password combination to gain access to the fantasy game league website 420. Once connected, the computer device 500 may interact with the fantasy game league website 420 to browse the various web pages associated with the fantasy game league website 420. The interaction may include, among other things, participating in a player draft, conducting player transactions, setting rosters for fantasy games, and participating in auctions to purchase portions of other web pages.

FIG. 6 illustrates an embodiment of a mobile device 600 communicable with the fantasy game league website 420. The mobile device 600 may be another example of a user device 450 shown in FIG. 4. The mobile device 600 may take the form of a smartphone or tablet computer. The embodiments are not limited to these examples, however. Specifically, the mobile device 600 may include a fantasy game league application 610 operative on a processor component 605. The fantasy game league application 610 may access the fantasy game league web server 410 and, in turn, the fantasy game league website 420 over the network 405 using a wireless connection. If a login procedure is required to access the fantasy game league website 420, the user may be asked to provide a username/password combination to gain access to the fantasy game league website 420. Once connected, the mobile device 600 may interact with the fantasy game league website 420 to browse the various web pages associated with the fantasy game league website 420 just as a computer device 500. The interaction may include, among other things, participating in a player draft, conducting player transactions, setting rosters for fantasy games, and participating in auctions to purchase portions of other web pages.

As stated earlier, the auction component 432 shown in FIG. 4 provides users the opportunity to purchase a portion of a fantasy game league web page for a limited period of time via an auction type transaction. The winning bidder wins the ability to post graffiti on the purchased portion of the web page. The auction process may be further understood with reference to FIGS. 7-12 below.

FIG. 7 illustrates an embodiment of a computer screen image showing a list of fantasy game pages that may be auctioned. The computer screen image may be labeled as a “Main Auction” page 700 within fantasy game league website 420. The “Main Auction” page 700 may be accessed by a user device 450 such as, for instance, a user computer device 500 or a user mobile device 600 communicating with the fantasy game league web server 410 over network 405. The “Main Auction” page 700 within fantasy game league web site 420 may present criteria in the form of buttons that include the specific web pages 710 available for auction. For instance, the web pages within the fantasy game league website 420 available for auction may include, but are not necessarily limited to, the league home page 100, the various team home pages 200, and the various game pages 300. Each of these pages may have a space thereon reserved for auction such that the winning bidder may upload content to that space on the web page. The user device 450 may select one of the web pages available for auction by clicking the “select” button 720. Clicking the “select” button 720 may direct the user to a computer screen image displaying the auction status of the selected web page such as that shown in FIG. 8. The embodiments are not limited to this example.

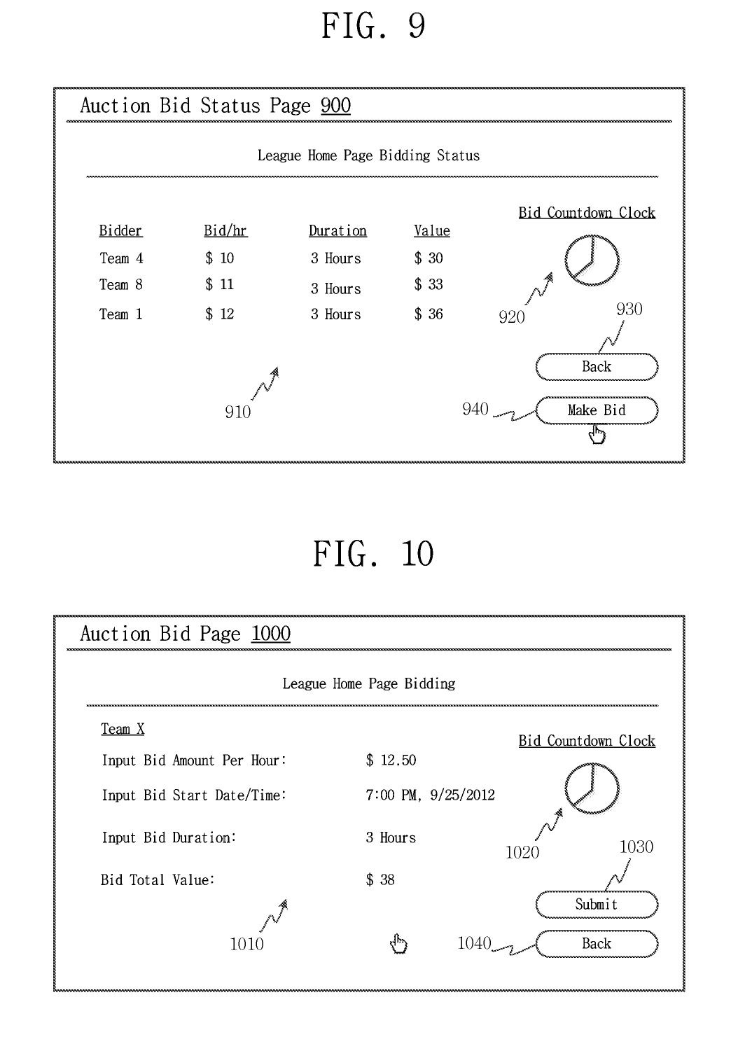

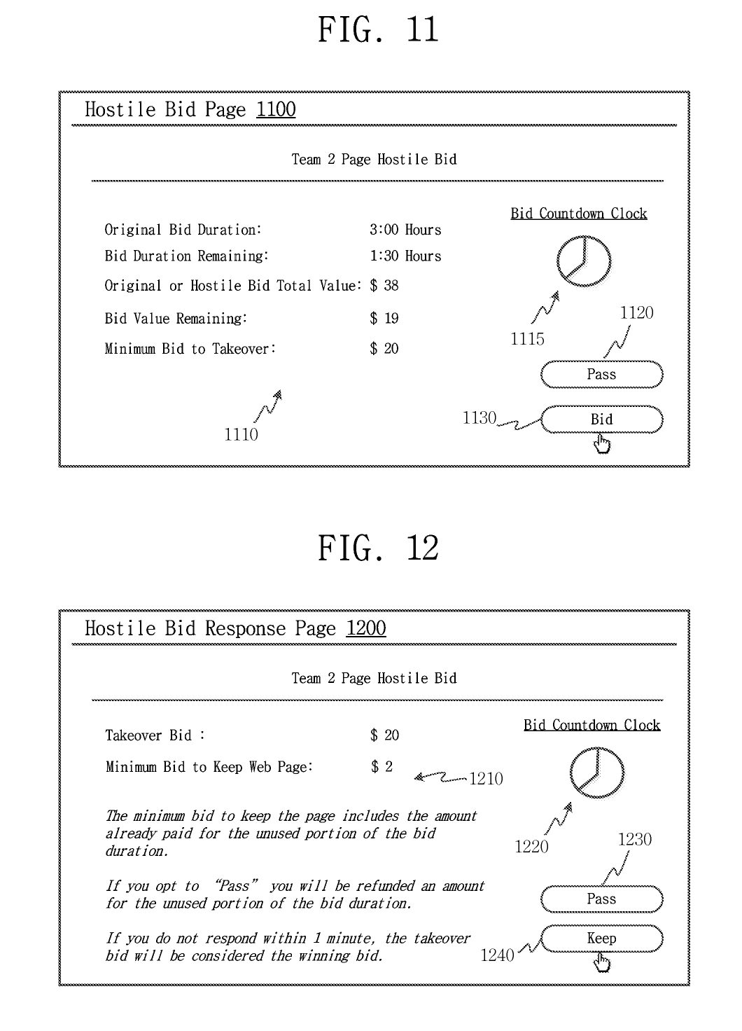

FIG. 8 illustrates an embodiment of a computer screen image showing the status of a particular fantasy game page. The computer screen image may be labeled as an “Auction Status” page 800 within fantasy game league website 420. The “Auction Status Page” page 800 within fantasy game league website 420 may present information 810 indicating the availability of the selected page to be auctioned. For instance, the status may be either “Available” or “Unavailable”. When the status is “Unavailable”, there may be some accompanying information pertaining to when the web page will be unavailable. The “Auction Status” page 800 may also include a “Start Auction” button 820, a “Hostile Takeover” button 830, and a “Back” button 840. The “Start Auction” button 820 may direct the user to a computer screen image displaying the bidding status of the selected web page such as that shown in FIG. 9. The “Hostile Takeover” button 830 may direct the user to a computer screen image displaying the bidding status of the selected web page such as that shown in FIG. 11. The “Back” button 840 may direct the user back to the computer screen image displaying the “Main Auction” page 700 such as that shown in FIG. 7. The embodiments are not limited to these examples.

FIG. 9 illustrates an embodiment of a computer screen image showing a bidding status for a fantasy game page. The computer screen image may be termed an “Auction Bid Status” page 900. The “Auction Bid Status” page 900 may be generated by the auction component 432 within fantasy game league website 420. The “Auction Bid Status” page 900 may be indicative of the present state of an auction for the league home page 100. The “Auction Bid Status” page 900 may present bidding information 910 and a bid countdown clock 920. The bidding information 910 may include columns for the bidder, bid, duration of ownership, and a total value of the bid. The bid countdown clock 920 may indicate how much time remains to submit the next bid. If a bid is not received before the bid countdown clock expires, the auction will be closed and the web page space awarded to the current high bid in terms of total value. The “Auction Bid Status” page 900 may also include a “back” button 930 and a “Make Bid” button 940. The “Back” button 930 may direct the user back to the computer screen image displaying the “Main Auction” page 700 such as that shown in FIG. 7. The “Make Bid” button 940 may direct the user to a computer screen image displaying an auction bid page such as that shown in FIG. 10. In the example of FIG. 9, the “Auction Bid Status” page 900 indicates that there have been three bids for the league home page 100 so far. The current bid is comes from “Team 1” for $12/hr. for a three hour duration for a total bid value of $36.

FIG. 10 illustrates an embodiment of a computer screen image for entering data pertaining to a bid for a fantasy game page, specifically the league home page 100. The computer screen image may be termed an “Auction Bid” page 1000. The “Auction Bid” page 1000 may present multiple criteria 1010 for a bid to be accepted. For example, the criteria 1010 may include a bid amount per hour, a date/time at which the ownership of the web page space will commence, and the duration of the web page space ownership. The auction component 428 may then calculate the total value for the bid. In this example, the bid is for $12.50/hr. for 3 hours starting on Sep. 25, 2012, 7:00 PM. The total bid value may then be calculated as $38. The user may click the “Submit” button 1030 to enter the bid prior to the expiration of the bid countdown clock 1020. Upon entry, the user may be directed back to the “Auction Bid Status” page 900 of FIG. 9 to see the updated status of the auction for the league home page 100. If the user decides not to enter a bid, the user may click the “Back” button 1040 to be directed back to the “Auction Bid Status” page 900 of FIG. 9. The embodiments are not limited to this example.

FIG. 11 illustrates an embodiment of a computer screen image for entering data pertaining to a hostile takeover bid for a fantasy game page. The computer screen image may be termed a “Hostile Bid” page 1100. The “Hostile Bid” page 1100 may be generated by the auction component 432 within fantasy game league website 420 in response to a user selecting the “Hostile Takeover” button 830 from the “Auction Status” page 800 in FIG. 8.

A hostile takeover may be used when a page has already been auctioned to another user. The “Hostile Bid” page 1100 may present the data indicative of the current state 1110 of an auctioned web page such as, for instance, the league home page 100. The data indicative of the current state 1110 may include rows identifying the original bid duration, the amount of ownership time remaining on the original winning bid, the total value of the original or hostile bid, the bid value remaining, and a calculation of a minimum bid needed to take over the remaining duration of the auctioned web page space. The minimum bid necessary to take over the remaining duration of the auctioned web page space may be calculated by determining the value remaining on the original bid and adding an incremental amount. In the example of FIG. 11, the duration remaining for the original winning bid is one half of its total duration (e.g., 1:30 of 3:00 hours). Thus, any takeover bid must be greater than one half of the original bid. This is illustrated by the “Bid Value Remaining” totaling $19 and the “Minimum Bid to Takeover” set at $20. The $20 is an incremental increase over the original bid. The amount of the increment is arbitrary and may be set to other incremental values so long as the total value of the original bid is increased as a result of a hostile takeover attempt.

The “Hostile Bid” page 1100 may also include a bid countdown clock 1115 to limit the time allowed to make a bid, a “Pass” button 1120 and a “Bid” button 1130. The “Pass” button 1120 may direct the user back to the computer screen image displaying the “Main Auction” page 700 such as that shown in FIG. 7. The “Bid” button 1130 may enter the hostile bid and send a notification to the current owner of the auctioned web page space. The notification may also direct the current owner to a hostile bid response page as illustrated in FIG. 12. The embodiments are not limited to this example.

FIG. 12 illustrates an embodiment of a computer screen image for entering data to respond to a hostile takeover bid for a fantasy game page. The computer screen image may be termed a “Hostile Bid Response” page 1200. The “Hostile Bid Response” page 1200 may present data indicative of a hostile takeover attempt 1210 of a web page owned by the recipient of the notification of the hostile takeover attempt. The data indicative of the hostile takeover attempt 1210 may include rows identifying the takeover bid amount, and a calculation of a minimum re-bid needed to keep remaining duration of the auctioned web page space. The minimum bid necessary to keep the remaining duration of the auctioned web page space may be calculated by adding an incremental value to the takeover bid and then determining what the total bid value would have been using the pro-rated incremental takeover bid. The original bid amount is subtracted and the result multiplied by the fractional duration of the remaining duration to determine the amount necessary to keep the web page space for the remaining duration of the original winning bid. The data indicative of the hostile takeover attempt 1210 may also include an explanation of what happens if the original winning bidder decides to “pass”. In that case, the original winning bidder will be refunded the prorated amount of the unused duration.

In the example of FIG. 12, the takeover bid is shown to be $20 and the minimum bid to keep the web page is $2. The $2 may be calculated by adding $1 to the takeover bid and recalculating what the total bid value would have been for the entire duration. In this case, the remaining duration is half the original duration. Thus, the total bid value would have been $42 based on a takeover bid of $21 for half the remaining duration. The original total bid value may then be subtracted from the new total bid value to obtain a difference of $4. The $4 difference may then be multiplied by the fractional duration of the remaining duration (e.g., 50% in this example) to obtain the minimum bid to keep the page as $2. The amount of the increment is arbitrary and may be set to other incremental values so long as the total value of the original bid is increased as a result of a hostile takeover attempt. The embodiments are not limited to this example.

The “Hostile Bid Response” page 1200 may also include a bid countdown clock 1220 that limits the amount of time to make a “keep” bid response. The “Hostile Bid Response” page 1200 may also include a “Pass” button 1230 and a “Keep” button 1240. The “Pass” button 1230 may direct the user back to the computer screen image displaying the “Main Auction” page 700 such as that shown in FIG. 7. The “Keep” button 1240 may enter the hostile response bid and send a notification back to the hostile bidder of the auctioned web page space. The notification may also direct the hostile bidder back to the “Hostile Bid” page 1100 as illustrated in FIG. 11 with a newly calculated “minimum bid to takeover” the web page space. The embodiments are not limited to this example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

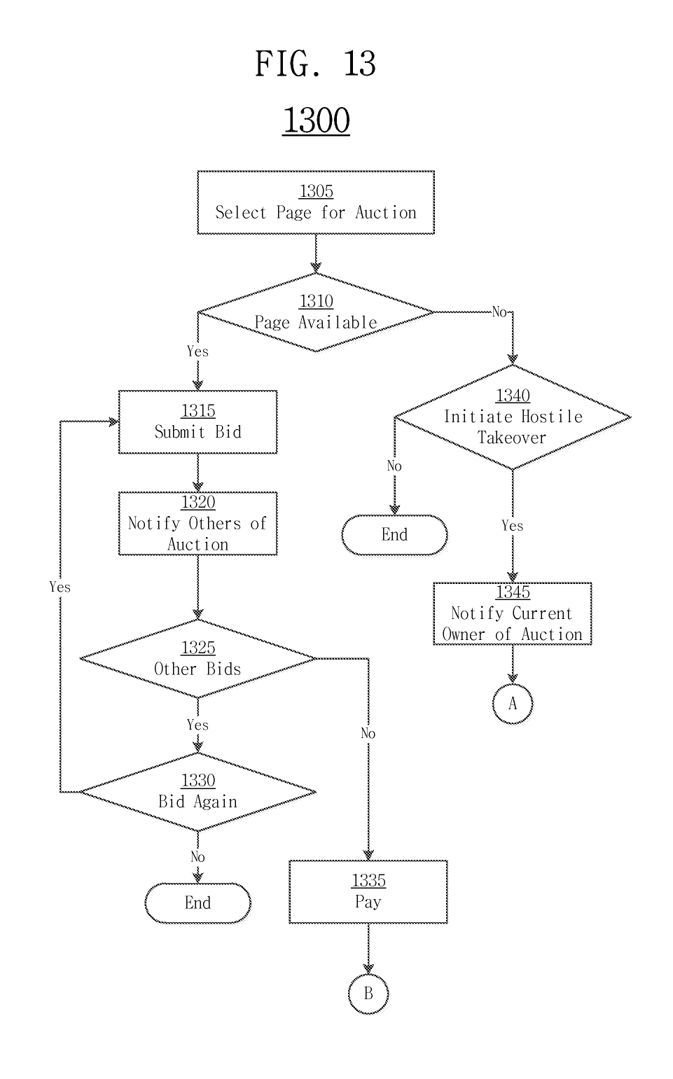

FIG. 13 illustrates one embodiment of a logic flow 1300. The logic flow 1300 may be representative of some or all of the operations executed by one or more embodiments described herein.

In the illustrated embodiment shown in FIG. 13, the logic flow 1300 may select a page for auction at block 1305. For example, the auction component 432 within the fantasy game league website 420 may present a “Main Auction” page 700 that presents multiple web pages available for auction within the fantasy game league website 420. Specifically, a portion of the listed web pages may be auctioned to a winning bidder. The list of web pages may include the league home page 100, the various team pages 200, and the various game pages 300. The embodiments are not limited to these examples.

In the illustrated embodiment shown in FIG. 13, the logic flow 1300 may determine if a selected web page is currently available for auction at block 1310. For example, the auction component 432 within the fantasy game league website 420 may present a “Auction Status” page 800 that presents data indicative of the status of the selected web page within the fantasy game league website 420. Specifically, the status may be available or unavailable. An available status may indicate that the selected web page is not currently auctioned. The unavailable status may indicate whether and when the selected web page has been auctioned. The embodiments are not limited to these examples.

In the illustrated embodiment shown in FIG. 13, the logic flow 1300 may accept bids for a selected web page at block 1315. For example, if the selected web page has been determined as available in block 1310, the user may input a bid for the web page. The auction component 432 within the fantasy game league website 420 may present an “Auction Bid Status” page 900 that presents data indicative of the status of the bidding for a selected web page within the fantasy game league website 420. Specifically, the prospective bidder is shown the bid history for the selected page. If the prospective bidder is the user that initiates the auction there may be no substantive data as yet to display. In either case the prospective bidder may make a bid by selecting the “Make Bid” button 940. This may cause the auction component 432 within the fantasy game league website 420 to present the “Auction Bid” page 1000 in which the bidder may input the bid criteria. The embodiments are not limited to these examples.

In the illustrated embodiment shown in FIG. 13, the logic flow 1300 may notify the other team owners of the auction at block 1320. For example, the auction component 432 within the fantasy game league website 420 may send a notification message to each of the team owners that one of them has initiated an auction for a selected web page within the fantasy game league website 420. The notification may then direct the other team owners to the “Auction Bid Status” page 900 that will present data indicative of the bidder's current bid for the selected web page within the fantasy game league website 420. The other team owners may then join the auction and make bids if desired. The embodiments are not limited to these examples.

In the illustrated embodiment shown in FIG. 13, the logic flow 1300 may determine whether there are other bids at block 1325. For example, the auction component 432 within the fantasy game league website 420 may return the bidder to the “Auction Bid Status” page 900. The “Auction Bid Status” page 900 will present the bidder's current bid and update itself after any other bids have been received. A bid countdown clock 920 may indicate how much time remains before the auction will close unless a new bid is received. The embodiments are not limited to these examples.

In the illustrated embodiment shown in FIG. 13, the logic flow 1300 may determine whether a team owner wishes to bid again at block 1330. For example, the auction component 432 within the fantasy game league website 420 may present the “Auction Bid Status” page 900 that presents data indicative of the status of the bidding for the selected web page within the fantasy game league website 420. Specifically, a prospective bidder is shown the bid history for the selected page. The prospective bidder may make another bid by selecting the “Make Bid” button 940. This may cause the logic flow 1300 to return to block 1315 where the process for submitting a bid is repeated. The embodiments are not limited to these examples.

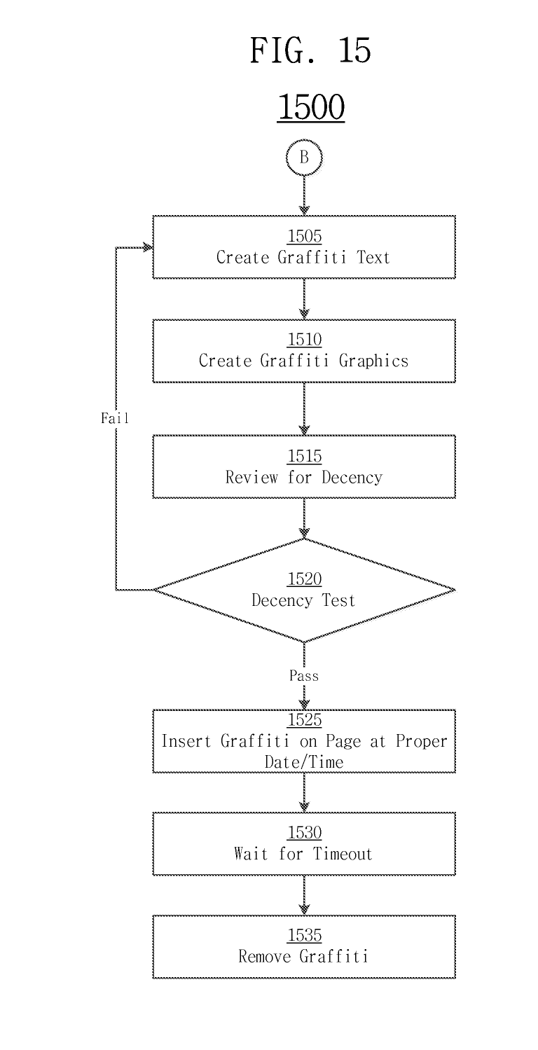

In the illustrated embodiment shown in FIG. 13, the logic flow 1300 may accept payment for an auctioned portion of a web page at block 1335. For example, if no further bids are received prior to a timeout of the bid countdown clock 920, the auction component 432 within the fantasy game league website 420 may interact with the winning bidder to collect payment for the amount of the winning bid. Upon collecting payment the auction component 432 may direct the winning bidder to a web page designed to allow the winning bidder to upload text and or graphics to be inserted into the selected web page at the time and for the duration indicated by the auction results. This process is described further with reference to FIG. 15. The embodiments are not limited to these examples.

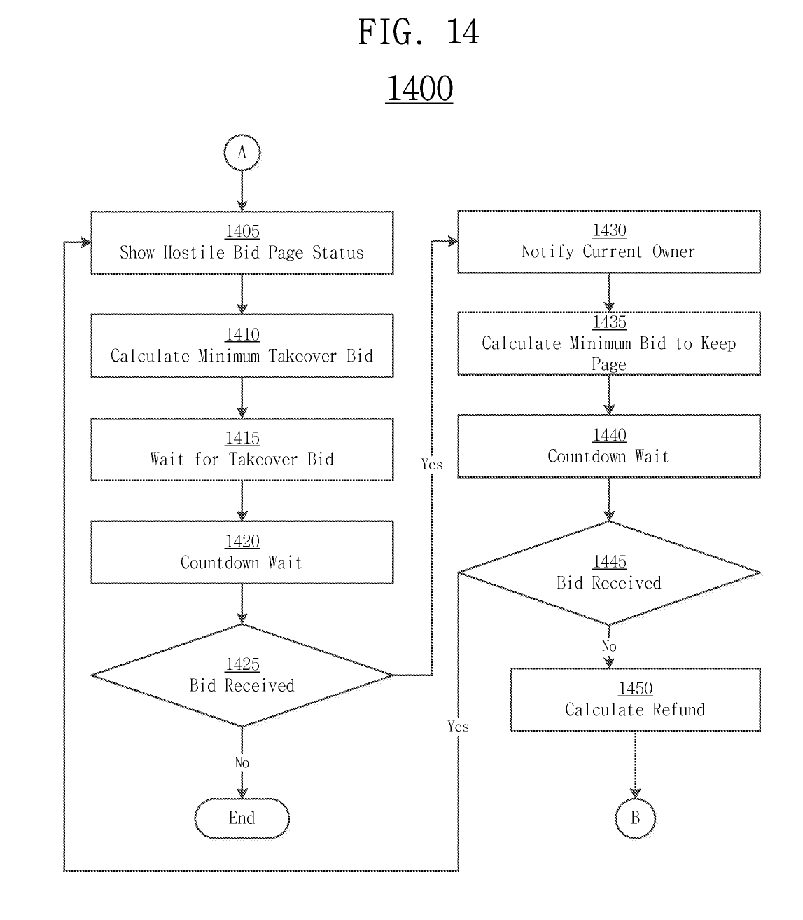

In the illustrated embodiment shown in FIG. 13, the logic flow 1300 may initiate a hostile takeover auction for a selected web page at block 1340. For example, if the selected web page has been determined as unavailable in block 1310, the user may still attempt or acquire or takeover the page from the previous winning bidder. The auction component 432 within the fantasy game league website 420 may send a notification message to the team owner that currently owns the web page at block 1345 that another team owner has initiated a hostile takeover auction for the selected web page within the fantasy game league website 420. The auction component 432 within the fantasy game league website 420 may then direct the hostile bidder to the “Hostile Bid” page 1100. The hostile takeover process may be described with reference to FIG. 14. The embodiments are not limited to these examples.

FIG. 14 illustrates one embodiment of a logic flow 1400. The logic flow 1400 may be representative of some or all of the operations executed by one or more embodiments described herein.

In the illustrated embodiment shown in FIG. 14, the logic flow 1400 may show the hostile bid page status at block 1405. For example, the auction component 432 within the fantasy game league website 420 may present a “Hostile Bid” page 1100 that presents data indicative of the current state 1110 of the hostile takeover attempt and may include rows identifying the original bid duration, the amount of ownership time remaining on the original winning bid, the total value of the original or hostile bid, the bid value remaining, and a calculation of a minimum bid needed to take over the remaining duration of the auctioned web page space. The minimum bid necessary to take over the remaining duration of the auctioned web page space may be calculated at block 1410 by determining the value remaining on the original winning bid and adding an incremental amount. The embodiments are not limited to these examples.

In the illustrated embodiment shown in FIG. 14, the logic flow 1400 may wait for a takeover bid at block 1415. For example, the auction component 432 within the fantasy game league website 420 may wait for the hostile bidder to make a takeover bid by clicking the “Bid” button 1120 on “Hostile Bid” page 1100. The logic flow 1400 may initiate a countdown wait for a takeover bid at block 1415. For example, the auction component 432 within the fantasy game league website 420 may limit the time allowed to make a bid using a bid countdown clock 1115. If a bid is not received at block 1425 of FIG. 14, the hostile auction terminates. If a bid is received at block 1425 of FIG. 14, the auction component 432 within the fantasy game league website 420 may send the current owner a notification of the takeover bid at block 1430. The embodiments are not limited to these examples.

In the illustrated embodiment shown in FIG. 14, the logic flow 1400 may calculate a minimum bid to keep the web page at block 1435. For example, the auction component 432 within the fantasy game league website 420 may calculate the minimum bid necessary to keep the remaining duration of the auctioned web page space by adding an incremental value to the takeover bid and then determining a new total bid value by dividing the incremental takeover bid by a fractional remaining duration. The original bid amount is subtracted and the result multiplied by the fractional remaining duration to determine the amount necessary to keep the web page space for the remaining duration of the original winning bid. The embodiments are not limited to these examples.

In the illustrated embodiment shown in FIG. 14, the logic flow 1400 may implement another countdown period at block 1440. If a bid is received at block 1445, control is returned to block 1405 where the hostile bid page status is shown to the hostile bidder. If a bid is not received at block 1445, a refund may be calculated for the current web page owner due to the loss of the remainder of the duration of web page space ownership. The refund may be calculated as the unused prorated portion of the original bid value. The hostile bidder may then be directed to a web page designed to allow the hostile bidder to upload text and or graphics to be inserted into the selected web page at the time and for the duration indicated by the hostile takeover auction results. This process is described further with reference to FIG. 15. The embodiments are not limited to these examples.

FIG. 15 illustrates one embodiment of a logic flow 1500. The logic flow 1500 may be representative of some or all of the operations executed by one or more embodiments described herein.

In the illustrated embodiment shown in FIG. 15, the logic flow 1500 may create graffiti text at block 1505. For example, the page assembly component 436 within the fantasy game league website 420 may accept text input from a winning auction bidder as to the text to be displayed in the web page portion of the web page within the fantasy game league website 420 just acquired. The text input may be typed into a designated area or may be uploaded from another computer device. The embodiments are not limited to these examples.

In the illustrated embodiment shown in FIG. 15, the logic flow 1500 may create graffiti graphics at block 1510. For example, the page assembly component 436 within the fantasy game league website 420 may accept graphical input from a winning auction bidder as to any graphics to be displayed in the web page portion of the web page within the fantasy game league website 420 just acquired. The graphics input may input into a designated area or may be uploaded from another computer device. The embodiments are not limited to these examples.

The term graffiti may refer to a combination of text and graphics. The graffiti may be created by the winning auction bidder with the intent that it be inserted into the web page space just acquired by the auction. This allows various team owners to competitively purchase space on one another's fantasy game league team pages and place messages (e.g., graffiti) on the page. The intent of the messages may be to “trash talk” a rival in a competitive manner.

In the illustrated embodiment shown in FIG. 15, the logic flow 1500 may review the graffiti text and graphics against decency standards at block 1515. For example, the auction component 432 within the fantasy game league website 420 may screen the language and graphics supplied by the winning auction bidder to ensure that any decency standards in force by the fantasy game league website 420 are not violate. If any decency standards are violated according to block 1520, control may be returned to block 1505 with a message that the proposed graffiti violates the decency standards of the fantasy game league website 420. Otherwise, the graffiti will be allowed to be posted on the acquired web page space. The embodiments are not limited to these examples.

In the illustrated embodiment shown in FIG. 15, the logic flow 1500 may insert the graffiti text and graphics at block 1525. For example, the page assembly component 436 may re-construct the web page to include the graffiti text and graphics at the appropriate location in the web page. The newly constructed web page will replace the current web page according to the schedule set out in the auction results. Thus, the new web page will appear when the date and time specified in the auction results occurs. For example, if the auction resulted in acquisition of the fantasy game league home page 100, the graffiti may be inserted in the space reserved for graffiti 170a-b. The embodiments are not limited to this example.

In the illustrated embodiment shown in FIG. 15, the logic flow 1500 may wait for the duration parameter to timeout at block 1530. For example, the auction component 432 within the fantasy game league website 420 may monitor the duration parameter and, upon timeout, send an instruction to the fantasy game page assembly component 436 to de-construct the web page at issue to remove the graffiti that was previously installed at block 1535. The embodiments are not limited to this example.

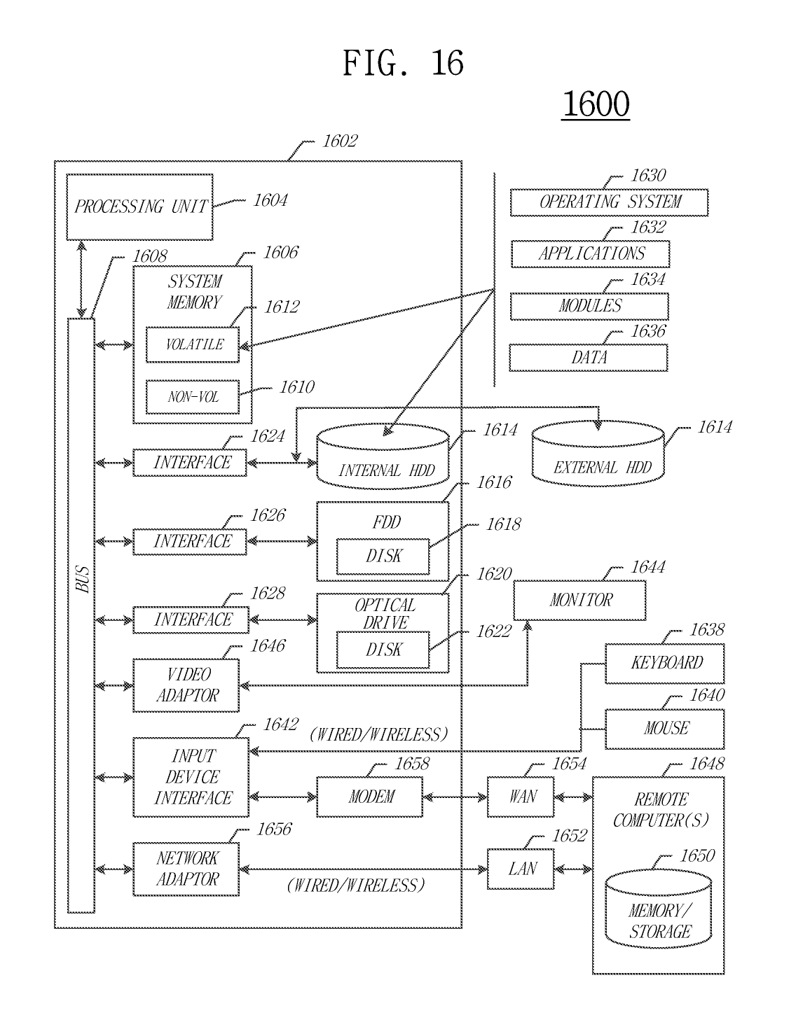

FIG. 16 illustrates an embodiment of an exemplary computing architecture 1600 suitable for implementing various embodiments as previously described. In one embodiment, the computing architecture 1600 may comprise or be implemented as part of an electronic device. The embodiments are not limited in this context.

As used in this application, the terms “system” and “component” are intended to refer to a computer-related entity, either hardware, a combination of hardware and software, software, or software in execution, examples of which are provided by the exemplary computing architecture 1600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1600.

As shown in FIG. 16, the computing architecture 1600 comprises a processing unit 1604, a system memory 1606 and a system bus 1608. The processing unit 1604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1604.

The system bus 1608 provides an interface for system components including, but not limited to, the system memory 1606 to the processing unit 1604. The system bus 1608 can be any of several types of bus structure that may further interconnect to a memory bus (with or without a memory controller), a peripheral bus, and a local bus using any of a variety of commercially available bus architectures. Interface adapters may connect to the system bus 1608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 16, the system memory 1606 can include non-volatile memory 1610 and/or volatile memory 1612. A basic input/output system (BIOS) can be stored in the non-volatile memory 1610.

The computer 1602 may include various types of computer-readable storage media in the form of one or more lower speed memory units, including an internal (or external) hard disk drive (HDD) 1614, a magnetic floppy disk drive (FDD) 1616 to read from or write to a removable magnetic disk 1618, and an optical disk drive 1620 to read from or write to a removable optical disk 1622 (e.g., a CD-ROM or DVD). The HDD 1614, FDD 1616 and optical disk drive 1620 can be connected to the system bus 1608 by a HDD interface 1624, an FDD interface 1626 and an optical drive interface 1628, respectively. The HDD interface 1624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1610, 1612, including an operating system 1630, one or more application programs 1632, other program modules 1634, and program data 1636. In one embodiment, the one or more application programs 1632, other program modules 1634, and program data 1636 can include, for example, the various applications and/or components of the system 100.

A user can enter commands and information into the computer 1602 through one or more wire/wireless input devices, for example, a keyboard 1638 and a pointing device, such as a mouse 1640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1604 through an input device interface 1642 that is coupled to the system bus 1608, but can be connected by other interfaces such as a parallel port, IEEE 1394 serial port, a game port, a USB port, an IR interface, and so forth.

A monitor 1644 or other type of display device is also connected to the system bus 1608 via an interface, such as a video adaptor 1646. The monitor 1644 may be internal or external to the computer 1602. In addition to the monitor 1644, a computer typically includes other peripheral output devices, such as speakers, printers, and so forth.

The computer 1602 may operate in a networked environment using logical connections via wire and/or wireless communications to one or more remote computers, such as a remote computer 1648. The remote computer 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wire/wireless connectivity to a local area network (LAN) 1652 and/or larger networks, for example, a wide area network (WAN) 1654. Such LAN and WAN networking environments are commonplace in offices and companies, and facilitate enterprise-wide computer networks, such as intranets, all of which may connect to a global communications network, for example, the Internet.

When used in a LAN networking environment, the computer 102 is connected to the LAN 1652 through a wire and/or wireless communication network interface or adaptor 1656. The adaptor 1656 can facilitate wire and/or wireless communications to the LAN 1652, which may also include a wireless access point disposed thereon for communicating with the wireless functionality of the adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wire and/or wireless device, connects to the system bus 1608 via the input device interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with wire and wireless devices or entities using the IEEE 802 family of standards, such as wireless devices operatively disposed in wireless communication (e.g., IEEE 802.19 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.19x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system, comprising:
a processor component; and
an auction component operative on the processor component to:
receive a selection indicative of a portion of a web page from a website to be auctioned;
accept bids from one or more bidders for the portion of the web page; and
receive payment for the portion of the web page from a winning bidder, and
a page assembly component operative on the processing component to:
receive text and/or graphics to be inserted into the portion of the web page; and
re-construct the web page by placing the received text and/or graphics into the portion of the web page.

2. The system of claim 1, the auction component operative on the processor component to provide bid status updates for the portion of the web page to the one or more bidders.

3. The system of claim 1, the page assembly component operative on the processor component to perform a decency check of the text and/or graphics to ensure compliance with any decency standards of the website.

4. The system of claim 1, the bids including: an amount per time period, a duration, and a start date and time.

5. The system of claim 4, the auction component operative on the processor component to calculate a total bid value by multiplying the amount per time period by the duration.

6. The system of claim 5, the auction component operative on the processor component to:
re-open bidding on the portion of the web page already auctioned;
calculate a minimum takeover bid for the portion of the web page already auctioned; and
accept a takeover bid for the portion of the web page already auctioned.

7. The system of claim 6, the auction component operative on the processor component to calculate a minimum takeover bid for the portion of the web page already auctioned by determining the value remaining on an original winning bid based on the remaining duration and adding an incremental amount.

8. The system of claim 6, the auction component operative on the processor component to:
notify the winning bidder of the takeover bid;
calculate a minimum keep bid for the portion of the web page already auctioned; and
accept a keep bid for the portion of the web page already auctioned.

9. The system of claim 8, the auction component operative on the processor component to calculate a minimum keep bid for the portion of the web page already auctioned by:
adding an incremental value to the takeover bid to obtain an incremental takeover bid;
determining a new total bid value by dividing the incremental takeover bid by a fractional remaining duration;
subtracting the original bid amount from the new total bid value to obtain a difference; and
multiplying the difference by the fractional remaining duration to obtain the minimum keep bid.

10. The system of claim 4, the page assembly component operative on the processor component to de-construct the web page by removing the text and/or graphics upon expiration of the duration.

11. The system of claim 1, the website being a fantasy game league website.

12. The system of claim 11, the web pages of the fantasy game league website including at least one of a fantasy game league home web page, a fantasy game team home web page, and a fantasy game web page.

13. A computer-implemented method, comprising:
receiving a selection indicative of a portion of a web page from a website to be auctioned;
accepting bids from one or more bidders for the portion of the web page;
receiving payment for the portion of the web page from a winning bidder,
receiving text and/or graphics to be inserted into the portion of the web page; and
re-constructing the web page by placing the received text and/or graphics into the portion of the web page.

14. The computer-implemented method of claim 13, further comprising providing bid status updates for the portion of the web page to the one or more bidders.

15. The computer-implemented method of claim 13, further comprising performing a decency check of the text and/or graphics to ensure compliance with any decency standards of the website.

16. The computer-implemented method of claim 13, the bids including: an amount per time period, a duration, and a start date and time.

17. The computer-implemented method of claim 16, further comprising calculating a total bid value by multiplying the amount per time period by the duration.

18. The computer-implemented method of claim 17, further comprising:
re-opening bidding on the portion of the web page already auctioned;
calculating a minimum takeover bid for the portion of the web page already auctioned; and
accepting a takeover bid for the portion of the web page already auctioned.

19. The computer-implemented method of claim 18, further comprising calculating a minimum takeover bid for the portion of the web page already auctioned by determining the value remaining on an original winning bid based on the remaining duration and adding an incremental amount.

20. The computer-implemented method of claim 18, further comprising:
notifying the winning bidder of the takeover bid;
calculating a minimum keep bid for the portion of the web page already auctioned; and
accepting a keep bid for the portion of the web page already auctioned.

21. The computer-implemented method of claim 20, further comprising calculating the minimum keep bid for the portion of the web page already auctioned by:
adding an incremental value to the takeover bid to obtain an incremental takeover bid;
determining a new total bid value by dividing the incremental takeover bid by a fractional remaining duration;
subtracting the original bid amount from the new total bid value to obtain a difference; and
multiplying the difference by the fractional remaining duration to obtain the minimum keep bid.

22. The computer-implemented method of claim 16, further comprising de-constructing the web page by removing the text and/or graphics upon expiration of the duration.

23. The computer-implemented method of claim 13, the website being a fantasy game league website.

24. The computer-implemented method of claim 23, the web pages of the fantasy game league website including at least one of a fantasy game league home web page, a fantasy game team home web page, and a fantasy game web page.

25. At least one computer-readable storage medium comprising instructions that, when executed, cause a system to:
receive a selection indicative of a portion of a web page from a website to be auctioned;
accept bids from one or more bidders for the portion of the web page;
receive payment for the portion of the web page from a winning bidder,
receive text and/or graphics to be inserted into the portion of the web page; and
re-construct the web page by placing the received text and/or graphics into the portion of the web page.

26. The computer-readable storage medium of claim 25, comprising instructions that when executed cause the system to provide bid status updates for the portion of the web page to the one or more bidders.

27. The computer-readable storage medium of claim 25, comprising instructions that when executed cause the system to perform a decency check of the text and/or graphics to ensure compliance with any decency standards of the website.

28. The computer-readable storage medium of claim 25, the bids including: an amount per time period, a duration, and a start date and time.

29. The computer-readable storage medium of claim 28, comprising instructions that when executed cause the system to calculate a total bid value by multiplying the amount per time period by the duration.

30. The computer-readable storage medium of claim 29, comprising instructions that when executed cause the system to:
re-open bidding on the portion of the web page already auctioned;
calculate a minimum takeover bid for the portion of the web page already auctioned; and
accept a takeover bid for the portion of the web page already auctioned.

31. The computer-readable storage medium of claim 30, comprising instructions that when executed cause the system to calculate a minimum takeover bid for the portion of the web page already auctioned by determining the value remaining on an original winning bid based on the remaining duration and adding an incremental amount.

32. The computer-readable storage medium of claim 30, comprising instructions that when executed cause the system to:
notify the winning bidder of the takeover bid;
calculate a minimum keep bid for the portion of the web page already auctioned; and
accept a keep bid for the portion of the web page already auctioned.

33. The computer-readable storage medium of claim 32, comprising instructions that when executed cause the system to calculate the minimum keep bid for the portion of the web page already auctioned by:
adding an incremental value to the takeover bid to obtain an incremental takeover bid;
determining a new total bid value by dividing the incremental takeover bid by a fractional remaining duration;
subtracting the original bid amount from the new total bid value to obtain a difference; and
multiplying the difference by the fractional remaining duration to obtain the minimum keep bid.

34. The computer-readable storage medium of claim 28, comprising instructions that when executed cause the system to de-construct the web page by removing the text and/or graphics upon expiration of the duration.

35. The computer-readable storage medium of claim 25, the website being a fantasy game league website.

36. The computer-readable storage medium of claim 35, the web pages of the fantasy game league website including at least one of a fantasy game league home web page, a fantasy game team home web page, and a fantasy game web page.
